(19) United States
(12) Patent Application Publication
(10) Pub. No.: US 2011/0188689 A1
(43) Pub. Date: Aug. 4, 2011

(54) CONDUCTION DEVICE FOR A HEARING APPARATUS AND METHOD FOR PRODUCING A CONDUCTION DEVICE

(75) Inventors: DANIELA BECK, ERLANGEN (DE); BJÖRN FREELS, NUERNBERG (DE); ULI GOMMEL, ERLANGEN (DE); HOLGER KRAL, FUERTH (DE)

(73) Assignee: SIEMENS MEDICAL INSTRUMENTS PTE. LTD., SINGAPORE (SG)

(21) Appl. No.: 13/018,758

(22) Filed: Feb. 1, 2011

(30) Foreign Application Priority Data
Feb. 1, 2010 (DE) 10 2010 006 469.6

(51) Int. Cl. H04R 25/00; B23P 11/00

(52) U.S. Cl. 381/328; 29/428

(57) ABSTRACT

A hearing apparatus, more particularly a hearing aid, generally requires sound or electrical signals to be conducted from a housing, worn outside of an auditory canal of a user, to an earpiece which has been inserted into the auditory canal. An appropriate conduction device often has a soft tube. The tube must be fixedly connected to the earpiece so that the latter can be pulled out of the auditory canal using the tube. Nevertheless, the connection between the tube and the earpiece is made detachable by an appropriate plug so that the earpiece can be cleaned. The plug is attached as securely as possible to the soft tube. One end of the tube and a region of the plug may be encapsulated by a material by insert molding or the tube and the plug may be welded together. A method for producing a conduction device is also provided.

### CROSS-REFERENCE TO RELATED APPLICATION

This application claims the priority, under 35 U.S.C. §119, of German Patent Application DE 10 2010 006 469.6, filed Feb. 1, 2010; the prior application is herewith incorporated by reference in its entirety.

### BACKGROUND OF THE INVENTION

### Field of the Invention

The invention relates to a conduction device for a hearing apparatus. The term hearing apparatus, as used herein, is understood to mean a hearing aid, in particular. However, the term also includes other portable acoustic instruments, such as headsets, receivers or the like. The conduction device for the hearing apparatus includes a flexible conduction element for conducting sound or electrical signals in an auditory canal. By way of example, that can be a sound tube. The conduction device moreover includes a coupling element for the detachable connection of one end of the conduction element to an element of the hearing apparatus, which is constructed to be disposed in the auditory canal. By way of example, that can be an earpiece. The invention also relates to a method for producing a conduction device.

Hearing aids are portable hearing apparatuses used to support the hard of hearing. In order to make concessions for numerous individual requirements, different types of hearing aids are provided, e.g. behind-the-ear (BTE) hearing aids, hearing aids with an external receiver (receiver in the canal [RIC]) and in-the-ear (ITE) hearing aids, for example concha hearing aids or canal hearing aids (ITE, CIC) as well. The hearing aids, which were listed in an exemplary manner, are worn on the concha or in the auditory canal. Furthermore, bone conduction hearing aids, implantable or vibrotactile hearing aids are also commercially available. In that case, the damaged sense of hearing is stimulated either mechanically or electrically.

In principle, the main components of hearing aids are an input transducer, an amplifier and an output transducer. In general, the input transducer is a sound receiver, e.g. a microphone, and/or an electromagnetic receiver, e.g. an induction coil. The output transducer is usually constructed as an electroacoustic transducer, e.g. a miniaturized loudspeaker, or as an electromechanical transducer, e.g. a bone conduction receiver. The amplifier is usually integrated into a signal-processing unit. That basic construction is illustrated in FIG. 1 using the example of a behind-the-ear hearing aid. One or more microphones 2 for recording sound from the surroundings are installed in a hearing-aid housing 1 to be worn behind the ear. A signal-processing unit 3, likewise integrated into the hearing-aid housing 1, processes the microphone signals and amplifies them. An output signal of the signal-processing unit 3 is transferred to a loudspeaker or receiver 4, which emits an acoustic signal. If necessary, the sound is conducted to the eardrum of the wearer of the hearing aid by a sound tube, which is fixed to an ear mold in the auditory canal. A battery 5, which is likewise integrated into the hearing-aid housing 1, supplies the hearing aid and, in particular, the signal-processing unit 3, with energy.

An ear mold is an element of the hearing aid that is disposed in the auditory canal of the wearer of the hearing aid. A flexible earpiece can also be used in place of an ear mold, with the former being formed of an elastic material, e.g. silicone, and adapting to the shape of the auditory canal when being introduced therein.

Two aspects are particularly important for the connection between the ear mold and the sound tube: on one hand, the ear mold must be connected securely enough to the sound tube so that the former can be pulled out of the auditory canal together with the sound tube. On the other hand, however, it must also be simple for a user to detach the ear mold, for example in order to be able to clean or replace the earpiece. A connection that satisfies these two criteria is referred to herein as a detachable connection.

In that context, it is known to connect an ear mold to a sound tube through the use of a snap-fit connection. To that end, the flexible sound tube has a coupling element at one end, which coupling element can be latched into the ear mold. By way of example, such a coupling element can be tubing onto which one end of the sound tube is plugged. In order to be able to hold the tubing in an ear mold through the use of a snap-fit connection, the tubing can have a bead at one end, through the use of which the tubing is held in the ear mold.

An in-the-ear loudspeaker is provided in a hearing aid with an external receiver (RIC), in which the former is constructed to be disposed in the auditory canal. A cable, rather than a sound tube, then connects the in-the-ear loudspeaker to an element of the hearing aid situated outside of the auditory canal. In that case, the cable includes one or more insulated wires, through the use of which electrical signals are conducted to the loudspeaker in the auditory canal. The wires can furthermore be encased by a tube-like sleeve in the cable. The loudspeaker can be pulled out of the auditory canal like an ear mold through the use of that sleeve. As in the case of a sound tube, a coupling element is also required in the sleeve of the cable in order to ensure that it is possible to connect the cable to the in-the-ear loudspeaker in a detachable manner.

While the connection of the coupling element to an ear mold or an in-the-ear loudspeaker should be detachable, the coupling element is attached to the sound tube or the sleeve of the cable in a permanent manner. Otherwise, a sound tube can, for example, become detached from the coupling element thereof if an earpiece has been jammed too tightly into an auditory canal. One problem in that case is that, firstly, the sound tube and, secondly, the coupling element are formed of different materials. A sound tube must be as soft and flexible as possible so that it adapts to a shape of the auditory canal. By contrast, the coupling element must be hard enough in order to be able to be held in the ear mold, for example through a form-locking connection formed by a snap-fit connection. A form-locking connection is one which connects two elements together due to the shape of the elements themselves, as opposed to a force-locking connection, which locks the elements together by force external to the elements. The same holds true in the case of a flexible cable for an in-the-ear loudspeaker and an associated coupling element. However, it is difficult to interconnect a body made of a soft and flexible material, on one hand, and a body made of a hard material, on the other hand, in a secure manner. That particularly holds true if the body formed of the soft material is repeatedly deformed by pulling. In order to connect a coupling element to a sound tube in a reliable manner, it is known to adhesively bond those two parts together.

### SUMMARY OF THE INVENTION

It is accordingly an object of the invention to provide a conduction device for a hearing apparatus and a method for producing a conduction device, which overcome the hereinafore-mentioned disadvantages of the heretofore-known devices and methods of this general type and which provide a robust conduction device, for conducting sound or electrical signals, for a hearing apparatus.

With the foregoing and other objects in view there is provided, in accordance with the invention, a conduction device for a hearing apparatus having an element intended to be disposed in an auditory canal. The conduction device comprises a conduction element for conducting sound or electrical signals in the auditory canal, the conduction element having end, and a coupling element for detachably connecting the end of the conduction element to the element of the hearing apparatus intended to be disposed in the auditory canal, the coupling element having a region. The end of the conduction element and the region of the coupling element being a) encapsulated together with a material by insert molding, and/or b) welded together.

In this case, insert molding means a method known per se, in which the material used for insert molding is liquefied and distributed around the components to be encapsulated by insert molding. The material subsequently cures and forms a sleeve. By encapsulating the conduction element and the coupling element together by insert molding, a body is formed from the material and surrounds the encapsulated regions of these two components.

An advantage of the conduction device according to the invention is that the conduction element, on one hand, and the coupling element, on the other hand, can be formed of different materials but nevertheless a reliable attachment of e.g. a hard coupling element to a soft, flexible conduction element, is made possible. Hence, particular care no longer has to be taken when constructing a conduction apparatus as to whether the material of the flexible conduction element is, for example, able to adhesively bond well to the material of the coupling element. Therefore, the conduction element can be produced from a material that is e.g. particularly skin-friendly and soft, and so a hearing-aid wearer does not have an uncomfortable feeling in the ear. The coupling element can likewise be produced from a material that is particularly suitable for the respectively desired detachable connection with the element of the hearing apparatus. A snap-fit connection and a screw connection are examples of such a detachable connection.

The invention is based on the recognition that materials particularly suited to producing a conduction element, on one hand, and a coupling element, on the other hand, can be interconnected particularly securely by a material by insert molding and by welding.

In accordance with another feature of the invention, the coupling element is formed at least in part of a rigid material. This rigid material is preferably a metal or a hard plastic.

The coupling element can then be particularly small. A rigid material then nevertheless affords the possibility of providing a detachable connection to the element of the hearing apparatus, through the use of which connection a sufficiently strong force can be transmitted to this element in such a way that it can be pulled out of the auditory canal by the conduction element.

In accordance with a further feature of the invention, the end of the conduction element and the region of the coupling element are encapsulated by an elastic material by insert molding. This is preferably a material that is identical to a material from which the conduction element is produced at least in part. The advantage emerging from this is that the body, formed by encapsulating the conduction element and the coupling element by insert molding, adheres particularly well to the conduction element.

In accordance with an added feature of the invention, the conduction element and the coupling element are plugged into one another. An advantage resulting from this in a conduction element for conducting sound is that no material reaches the interior of the conduction element or the interior of the coupling element during the insert molding and blocks a channel for conducting sound. In the case of welding, the plugging into one another prevents liquefied material from flowing into the channel and blocking the latter. In the case of a conduction element for conducting electrical signals, the plugging into one another protects connectors from also being encapsulated during the insert molding, which would prevent an electrical contact with the in-the-ear loudspeaker from being possible. During welding, this prevents the melting of an insulation of the wires and thereby e.g. causing short circuits between the wires.

With the objects of the invention in view, there is also provided a method for producing a conduction device for conducting sound or electrical signals to an element of a hearing apparatus in an auditory canal. The method comprises providing a conduction element for conducting sound or electrical signals, the conduction element having an end, providing a coupling element to be detachably connected to the element of the hearing apparatus, the coupling element having a region, defining a relative position of the coupling element and the end of the conduction element, and subsequently encapsulating the region of the coupling element and the end of the conduction element by insert molding, thereby attaching the coupling element to the end of the conduction element. The method according to the invention advantageously allows the production of a conduction device according to the invention. Hence this also results in the advantages explained in conjunction with the conduction device according to the invention.

In accordance with another mode of the invention, the end of the conduction element or the region of the coupling element to be encapsulated is treated at least in part by plasma before the insert molding. It is also possible for both parts to be treated by the plasma. In this case, plasma is a gas that wholly or partly is formed of free charge carriers, such as ions or electrons. A possible method for treating the conduction element or the coupling element by plasma resides in e.g. generating such plasma in surroundings of these components in such a way that a surface of the components comes into contact with the plasma. What is advantageously achieved by pre-treating a surface of the conduction element or the coupling element with plasma is that the material used in the insert molding bonds particularly securely to the pre-treated component.

With the objects of the invention in view, there is furthermore provided a method for producing a conduction device for conducting sound or electrical signals to an element of a hearing apparatus in an auditory canal. The method comprises providing a conduction element for conducting sound or electrical signals, the conduction element having an end, providing a coupling element to be detachably connected to the element of the hearing apparatus, plugging the end of the conduction element onto the coupling element, and subsequently welding the end of the conduction element onto the coupling element. This then results in a conduction device according to the invention. The conduction element and the coupling element then are interconnected in a particularly secure manner.

In accordance with a concomitant mode of the invention, in order to carry out the welding, a laser beam, to which a material of the conduction element is transparent, is preferably directed at that part of the coupling element located in the conduction element after being plugged on. In other words, a material of the conduction element or a wavelength of the laser beam light is selected in such a way that the laser beam can radiate through the material of the conduction element. The laser beam then heats a surface of the coupling element. This affords the possibility of heating a surface of the coupling element located within the conduction element and welding that surface to the conduction element. In other words, the two components are welded in a region that is completely inaccessible to tools.

An advantage of this development of the method is, firstly, that a welded connection can be produced in a particularly cost-effective manner. Moreover, the conduction element or the coupling element need not be embodied in such a way that the region to be welded is accessible to tools. Hence, provision can be made for a conduction device in which a shape is optimized to the effect of being able to conduct sound or electrical signals into the auditory canal without having an adverse effect on the comfort for the wearer of the hearing aid.

Other features which are considered as characteristic for the invention are set forth in the appended claims.

Although the invention is illustrated and described herein as embodied in a conduction device for a hearing apparatus and a method for producing a conduction device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, longitudinal-sectional view of a construction of a behind-the-ear hearing aid, without a sound tube and earpiece;

FIG. 2 is a longitudinal-sectional view of a sound tube with a plug attached thereto according to an embodiment of the conduction device of the invention as well as an earpiece; and

FIG. 3 is a longitudinal-sectional view of a sound tube with a plug attached thereto according to a further embodiment of the conduction device of the invention as well as an earpiece.

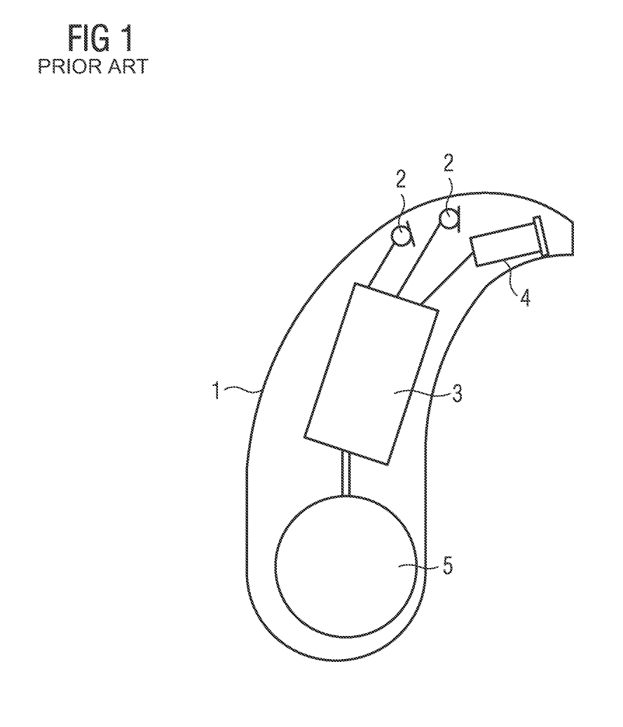

### DETAILED DESCRIPTION OF THE INVENTION

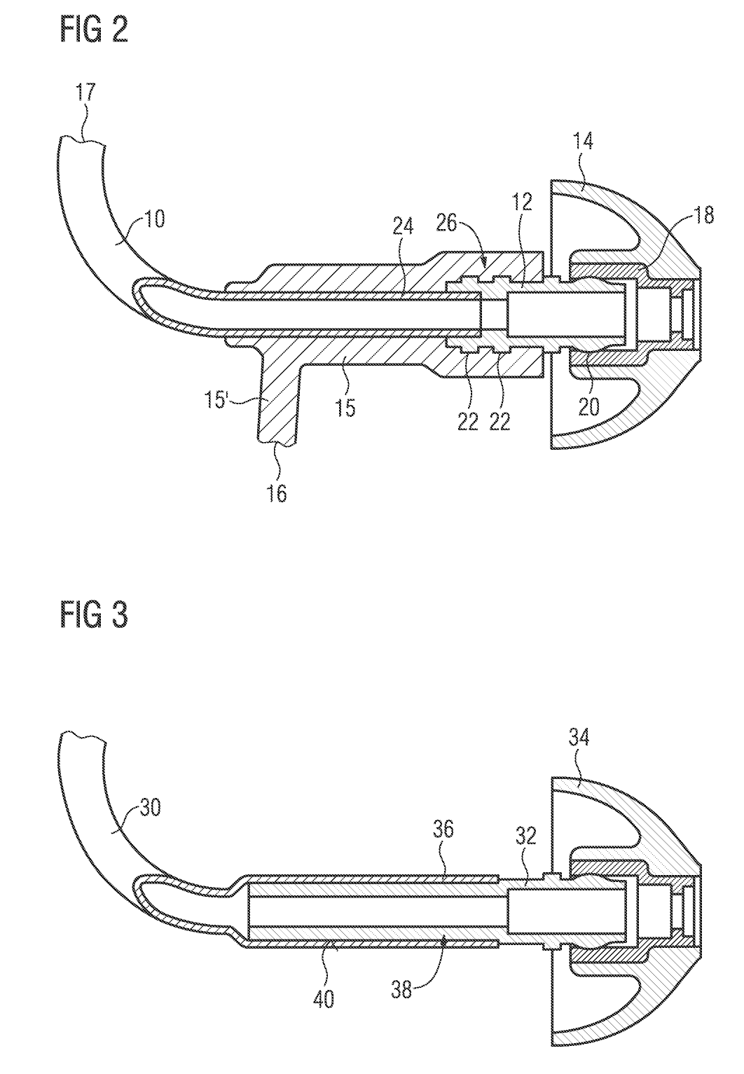

Referring now in detail to the figures of the drawings, which constitute preferred embodiments of the invention, and first, particularly, to FIG. 2 thereof, there is seen a sound tube 10, to one end of which a plug 12 is attached as a coupling element. The plug 12 connects the sound tube 10 to a flexible earpiece 14 or another element that can be inserted into an auditory canal. The earpiece 14 is a so-called dome, in which a dome-shaped region is formed of an elastic material, e.g. silicone. In the illustrated example, an assumption is made that the earpiece 14 has been inserted into an auditory canal (which is not illustrated in any more detail in FIG. 2) of a hearing-aid wearer.

A support 15 carries part of the weight of the sound tube 10 and the plug 12. The support 15 is located at the entry to the auditory canal. An arm 15′ of the support 15 rests against a concha of an auricula of the hearing-aid wearer. Only part of the arm 15′ is illustrated in FIG. 2. The part of the arm 15′ that has not been illustrated extends beyond a break line 16.

The sound tube 10 is likewise only illustrated in part in FIG. 2. Part of the sound tube 10 that is not illustrated extends beyond a break line 17, shown in FIG. 2, toward a housing of a behind-the-ear hearing aid. A receiver located in the housing generates sound, which is conducted through the sound tube 10 and the plug 12 to the earpiece 14.

The plug 12 is tubing with a rotationally symmetrical shape. It is formed of a rigid material. By way of example, the material can be a metal or a hard plastic such as polyether ether ketone (PEEK). An external diameter of the plug 12 varies along the longitudinal extent of the plug 12. As a result, rings 22 are formed on an external side of the plug 12 in addition to a bead 20.

The plug 12 is held in a socket 18 of the earpiece 14 by a snap-fit connection. To this end, the bead 20 of the plug 12 is disposed at an end sticking into the socket 18. The plug 12 is held in the socket 18 by a form-locking connection through the use of the bead 20. The socket 18 can be produced from a metal. The snap-fit connection can be opened by pulling apart the plug 12 and the earpiece 14. Neither the plug 12 nor the socket 18 is destroyed in the process.

The sound tube 10 and the plug 12 are held together by the support 15. The support 15 has been formed by encapsulating a tube end 24 of the sound tube 10 and a connection region 26 of the plug 12 by insert molding. The connection region includes the two rings 22. The material from which the support 15 is produced is soft and elastic like the sound tube 10. As a result, the tube end 24 adheres particularly well to the support 15. The support 15 can then also be produced from the same material as the sound tube 10. Then, the insert molding results in a particularly secure connection between these two components.

The rings 22 of the plug 12, together with the support 15, result in a form-locking connection in the connection region 26. The plug 12 is held in the support 15 by that form-locking connection. Although the support 15 is made from a relatively soft material, the plug 12 is securely held in the support 15 by the form-locking connection resulting from the rings 22.

The tube end 24 is inserted into a recess in the plug 12. As a result, none of the material from which the support 15 is made has reached the interior of the sound tube 10 or the plug 12 during the insert molding. The tube end can also be plugged onto the plug. This results in comparable protection from ingress of the material into the interior of the tube during the insert molding.

Instead of the support 15, the tube end 24 and the connection region 26 can also be encapsulated by insert molding to provide a sleeve that does not have an arm like the arm 15′ of the support 15.

The sound tube 10, the plug 12 and the support 15 form a conduction device. The earpiece 14 is an element of the hearing aid constructed to be disposed in the auditory canal.

A detachable connection, which corresponds to the snap-fit connection shown in FIG. 2 for connecting the sound tube 10 to the earpiece 14, can also be used for an in-the-ear loudspeaker. In this case, a tube with electrically insulated wires located therein is provided in place of the sound tube 10. Electrical signals are then conducted from an interior of a hearing-aid housing to the loudspeaker over these wires. The tube and the wires located therein together form a cable.

One end of the tube then can have a plug like the sound tube 10. However, in contrast to the plug 12, the plug for the loudspeaker is then provided with electrical connectors for the electrical coupling of the wires to corresponding connectors of the loudspeaker. The tube and the plug can likewise be held together by a sleeve, as is also formed by the support 15.

The cable, the plug and the sleeve, which are used to hold the two together, then form a conduction element for conducting electrical signals.

In order to couple the cable to the loudspeaker, the plug can be plugged either directly into the loudspeaker, or else into an earpiece for the in-the-ear loudspeaker.

In the last-mentioned case, the shape of the plug can be very similar to the shape of the plug 12. Hence the shape of the earpiece for the in-the-ear loudspeaker then also corresponds to the shape of the earpiece 14. An advantage then resulting from this is that there is no need to provide different earpieces for sound tubes, on the hand, and for cables of in-the-ear loudspeakers, on the other hand.

FIG. 3 shows a sound tube 30, which is held on an earpiece 34 by a plug 32. The sound tube 30 has a similar construction to the sound tube 10. The earpiece 34 is comparable to the earpiece 14. In the earpiece 34, the plug 32 is likewise held in a socket of the earpiece 34 by a snap-fit connection, as described previously in conjunction with the plug 12 and the earpiece 14. The sound tube 30 and the plug 32 form a conduction device through which sound is conducted to the earpiece 34.

The plug 32 is tubing with a rotationally symmetrical shape. It can be made of metal or a hard plastic such as PEEK. One tube end 36 of the sound tube 30 is plugged onto the plug 32. As a result, a connection region 38 of the plug 32 is located within the tube end 36. The connection region 38 and the tube end 36 are welded together.

A laser beam was directed at a surface 40 of the connection region 38 for the purposes of welding. In this case, a material from which the tube end 36 is made was transparent to the laser beam light or at least almost transparent thereto. As a result, the laser beam mainly heated the surface 40 of the plug 32. The welding securely connects the plug 32 to the tube end 36. A sleeve, as is formed by the support 15 shown in FIG. 2, is not required to hold the plug 32 in the sound tube 30. As a result, a diameter of the conduction device formed of the sound tube 30 and the plug 32 can be smaller in the region of the tube end 36 than in the configuration shown in FIG. 2.

It goes without saying that the connection shown in FIG. 3 between the sound tube 30 and the plug 32 can also be used to connect a tube of a cable to a corresponding plug.

In contrast to hearing aids in the prior art, the examples shown in FIG. 2 and FIG. 3 afford the possibility of detachably connecting a tube to an earpiece or an in-the-ear loudspeaker through the use of a plug, which is formed of a material that is suited particularly well to producing such a connection. The illustrated type of attachment always ensures that the tube and the plug are securely interconnected. More particularly, this also allows the use of a uniform outer shape for the plug for earpieces and loudspeakers at the same time. Then, the same components can always be used for producing different hearing aids. Only one type of plug needs to be provided, for example a plug like the plug 12 or the plug 32. This plug is then suitable both for connecting sound tubes and for connecting cables to the hearing aid elements to be disposed in the auditory canal.

The invention provides a possible way of permanently connecting a plug, made of metal or a hard plastic, to an end of a sound tube or a cable.

In the manner of performing this attachment shown as an example in FIG. 2, either the plug is plugged into the sound tube or the sound tube is initially mechanically deformed, for example by heating, in such a way that the end has a flared or expanded internal diameter and is subsequently plugged onto the plug. This configuration is then encapsulated by a material by insert molding, in which the material adheres to the tube after the insert molding. During the insert molding process, a support can be formed at the same time from the material. The plug is held in the material by a form-locking connection. The end of the tube to be encapsulated by insert molding and the plug can, for example, be pre-treated by plasma, which results in an improved connection between the material, used for insert molding, and the surfaces of the tube or the plug.

Insert molding can also be dispensed with in the embodiment of the invention shown in FIG. 3. In this case, the tube end 36 can likewise be mechanically deformed by heating before being plugged onto the plug 32 in such a way that the tube end 36 has a larger internal diameter than the rest of the tube 30.

The invention affords the possibility of securely connecting a plug made of a hard material to a flexible tube made of a comparatively soft material.

1. A conduction device for a hearing apparatus having an element intended to be disposed in an auditory canal, the conduction device comprising:
a conduction element for conducting sound or electrical signals in the auditory canal, said conduction element having end; and
a coupling element for detachably connecting said end of said conduction element to the element of the hearing apparatus intended to be disposed in the auditory canal, said coupling element having a region;
said end of said conduction element and said region of said coupling element being at least one of:
a) encapsulated together with a material by insert molding, or
b) welded together.

2. The conduction device according to claim 1, wherein said coupling element is formed at least in part of a rigid material.

3. The conduction device according to claim 2, wherein said rigid material is a metal or a hard plastic.

4. The conduction device according to claim 1, wherein said material is an elastic material encapsulating said end of said conduction element and said region of said coupling element by insert molding.

5. The conduction device according to claim 4, wherein said elastic material is a material identical to a material from which said conduction element is produced at least in part.

6. The conduction device according to claim 1, wherein said material encapsulates said end of said conduction element and said region of said coupling element by insert molding.

7. The conduction device according to claim 6, wherein said coupling element is held at said end of said conduction element by said material with a form-locking connection.

8. The conduction device according to claim 1, wherein said conduction element and said coupling element are plugged into one another.

9. The conduction device according to claim 1, wherein said conduction element is a sound tube for conducting sound and said coupling element has a through-hole allowing sound to escape from the conduction device at said end of said sound tube.

10. A method for producing a conduction device for conducting sound or electrical signals to an element of a hearing apparatus in an auditory canal, the method comprising the following steps:
providing a conduction element for conducting sound or electrical signals, the conduction element having an end;
providing a coupling element to be detachably connected to the element of the hearing apparatus, the coupling element having a region;
defining a relative position of the coupling element and the end of the conduction element; and
encapsulating the region of the coupling element and the end of the conduction element by insert molding, thereby attaching the coupling element to the end of the conduction element.

11. The method according to claim 10, which further comprises at least partly treating at least one of the end of the conduction element or the region of the coupling element at least in part with plasma before the insert molding step.

12. A method for producing a conduction device for conducting sound or electrical signals to an element of a hearing apparatus in an auditory canal, the method comprising the following steps:
providing a conduction element for conducting sound or electrical signals, the conduction element having an end;
providing a coupling element to be detachably connected to the element of the hearing apparatus;
plugging the end of the conduction element onto the coupling element; and
welding the end of the conduction element onto the coupling element.

13. The method according to claim 12, which further comprises carrying out the welding step by directing a laser beam, to which a material of the conduction element is transparent, at part of the coupling element located in the conduction element to heat a surface of the coupling element.
